(19) United States
(12) Patent Application Publication
(10) Pub. No.: US 2024/0386637 A1
(43) Pub. Date: Nov. 21, 2024

(54) METHOD FOR PROVIDING TRAINING IMAGE DATA FOR TRAINING A FUNCTION

(71) Applicant: Siemens Aktiengesellschaft, München (DE)

(72) Inventors: Maximilian Metzner, Bamberg (DE); Daniel Fiebag, Ingolstadt (DE); Sören Weißert, Aalen (DE)

(21) Appl. No.: 18/687,130

(22) PCT Filed: Jul. 29, 2022
(86) PCT No.: PCT/EP2022/071335

§ 371 Date: Feb. 27, 2024

(30) Foreign Application Priority Data
Aug. 30, 2021 (EP) 21193802.2

(51) Int. Cl. G06T 11/60; G06T 7/00

(52) U.S. Cl. CPC G06T 11/60; G06T 7/0006; G06T 2207/20081; G06T 2207/30141

(57) ABSTRACT

The invention relates to a computer-implemented method for providing training image data (TBD) for training a function, in particular an object recognition function (F0), the method comprising the following steps: S1 Providing at least one annotated image (AB), the annotated image (AB) having at least one object (01, 02, 031, 032, 041, 042, 043, 05) comprising an annotation (L1, L2) associated with the at least one object, the annotation describing an image region in which the at least one object (01, 02, 031, 032, 041, 042, 043, 05) is contained; S2 selecting an object (01, 02, 031, 032, 041, 042, 043, 05) in the annotated image (AB); S3 replacing the image region described by the annotation (L1, L2) with a region of another image in order to remove the selected object (01, 02, 031, 032, 041, 042, 043, 05) together with the annotation (L1, L2) associated with the selected object (01, 02, 031, 032, 041, 042, 043, 05) from the annotated image (AB) and produce a modified annotated image (MAB); S4 providing the training image data (TBD) containing the modified annotated image (MAB).

### CROSS REFERENCE TO RELATED APPLICATIONS

This present patent document is a § 371 nationalization of PCT Application Serial Number PCT/EP2022/071335, filed Jul. 29, 2022, designating the United States which is hereby incorporated in its entirety by reference. This patent document also claims the benefit of EP21193802 filed on Aug. 30, 2021, which is hereby incorporated in its entirety by reference.

### FIELD

Embodiments relate to a computer-implemented method and systems for providing or for generating and providing training image data for training a function. Embodiments further relate to the use of the aforementioned training image data for training a function and the use of the trained function to check the accuracy of the population of printed circuit boards in the production of printed circuit boards, for example to check whether all electronic components provided in a given process step are present and are attached to the correct locations.

### BACKGROUND

Machine learning methods, for example Artificial Neural Networks (ANN), have enormous potential for improving performance and robustness in image processing while at the same time reducing the effort involved in setup and maintenance. For example, Convolutional Neural Networks (CNN) are used for this purpose. Areas of application include image classification (for example, for a good/bad test), object recognition, pose estimation and segmentation.

The basis of all machine learning methods, for example ANNs and CNNs, is independent, data-based optimization of the program, in contrast to the explicit assignment of rules in classical programming. For example, in the case of CNNs, for the most part supervised learning methods are used for this purpose. These are characterized in that both exemplary data and the associated correct result, the so-called label, are required for the training.

Very many data sets, for example, 2D and/or 3D images, with a corresponding label are required for the training of CNNs. The label is typically created manually. While this requires little time in the case of classification (for example, good/bad), it is increasingly time-consuming in the case of object recognition, pose estimation and segmentation. This represents a substantial expense when using KI-based image processing solutions. There is therefore a lack of a method of automating this labeling for such methods (for example, object recognition, transferable to pose estimation or segmentation).

When using KI-based methods, the acquisition of correct training data represents one, if not the largest, cost factor.

There are existing approaches to generate the required training data synthetically with a digital twin as here an automated rejection of the label is relatively inexpensive and any amount of data may be generated (see also EP application from the applicant 20176860.3). The problem here is that the synthetic data cannot typically map all real optical properties and influences (e.g. reflections, natural lighting, etc.), or is extremely computationally intensive (cf. https://arxiv.org/pdf/1902.03334.pdf; here 400 compute clusters, each with a 16-core CPU with 112 GB of RAM, were used). Such trained networks are therefore fundamentally functional, but in reality, they are usually not completely robust (80% solution). Therefore, follow-up training with real, labeled data is also usually necessary in order to achieve the performance necessary for industrial use.

Another approach is so-called “data augmentation”. In this case, the original labeled data set is changed by image processing operations in such a way that the resulting image looks different for the algorithm, but the label of the original image may still be used unchanged, or at least may be converted directly. However, data augmentation makes a change, for example a conversion of the original label, for example by translation (shifting) and/or scaling, as the object together with the label typically does not remain in the same place on an “augmented” image. However, in certain applications, this method is prone to errors.

### BRIEF SUMMARY AND DESCRIPTION

The scope of the embodiments is defined solely by the appended claims and is not affected to any degree by the statements within this summary. The present embodiments may obviate one or more of the drawbacks or limitations in the related art.

Embodiments provide methods and systems for generating training image data.

In a first aspect, a method is provided that includes the following steps: S1 Providing at least one annotated image, the annotated image having at least one object that is recognizable including an annotation (label) assigned to the at least one object, the annotation describing or defining an image area (area of the image) in which the at least one object is contained, S2 Selecting an object in the annotated image, S3 Removing the image area described by the annotation in order to remove the selected object together with the annotation assigned to the selected object from the annotated image and thus producing a modified annotated image, and S4 Providing the training image data containing the modified annotated image.

The modified annotated image for the training image data that already contains the annotated image is added before the training image data is provided.

The method creates (real, non-synthetic) training image data in which each label is either present or not. In contrast to previous methods, not only is a labeled image optically changed (data augmentation), but for example the presence of individual objects to be detected, for example non-overlapping objects, is also influenced in a targeted manner. Thus, the relevant content of the data set (the training image data) is also adapted, as a result of which, in turn, an increase in the heterogeneity of the input data set may be achieved without the additional recording and labeling of further images. In this sense, data augmentation is a purely optical method that has no influence on the content of the training image data. For example, the number of objects in the image is not changed in data augmentation. For example, the recognition of components and the determination of their position on a printed circuit board may be mentioned. On the basis of the training image data, that is generated according to the method from the present disclosure, the correct population of a printed circuit board may be determined, for example, by a parts list comparison. Another example is the detection of good/bad printed circuit boards, in which the assessment of the solder joints (good/bad) is used as the basis for the assessment. However, the application of the present disclosure is not limited to the examples mentioned.

In one embodiment, it may be provided that the annotation/the label contains a border of the object. The border may be configured as a rectangle and is optimal in such a way that it delimits the smallest possible image area in which the bordered object may still be contained. This means that with a smaller border, the object will not be completely contained in the image area delimited by the smaller border.

In one embodiment, it may be provided that the annotated image has a background.

In one embodiment, it may be provided that, in addition, at least one image in which no objects are contained (for example, an empty (unpopulated) printed circuit board) is added to the training image data. In other words, it may be expedient to record an additional image of the same scene (of the same background) without objects.

In one embodiment, it may be provided that the at least one object is selected on the basis of the annotation (of the label) assigned to this object. In one embodiment, it may be provided that selection takes place automatically.

In one embodiment, it may be provided that the label (the annotation) of each object in the image contains information about identification (type, description, nature) of the object and/or its position on the image.

In one embodiment, it may be provided that the background has a digital image of a printed circuit board.

In one embodiment, it may be provided that the annotated image includes a multiplicity of objects.

In one embodiment, it may be provided that the objects are different.

Each object may have partial objects that may be combined into a whole-into an object. The partial objects may be configured to be structurally separate from one another. Alternatively, one or more objects may be configured as a structurally uniform part.

In one embodiment, it may be provided that the at least one object is configured as a digital image of an electronic component for populating a printed circuit board or of an electronic component of a printed circuit board.

In one embodiment, it may be provided that steps S2 and S3 are repeated until the modified annotated image no longer has any more objects (that is to say, for example, only the background) in order to generate a plurality of different modified annotated images, the different modified annotated images being added to the training image data.

In one embodiment, it may be provided that the annotated and the modified annotated image are processed in order to generate further annotated images, the further annotated images being added to the training image data.

In one embodiment, it may be provided that the removal of the image area described by the annotation includes overwriting the image area.

In one embodiment, it may be provided that the aforementioned image without objects contained therein is used to overwrite the image area.

In one embodiment, it may be provided that, for overwriting, a color, for example exactly one color, a random pattern or an area of another image, for example a background image, is used.

In one embodiment, it may be provided that the area of the other image corresponds to the image area, for example is of the same size and/or is in the same position.

In one embodiment, it may therefore be provided that the image area described by the annotation (and the at least one object contained therein) is replaced, for example overwritten, by the corresponding image area of the further scene (of the other image), for example a blank image (i.e., background without objects). As a result, the relevant image area occupied by the object is overwritten by the blank image area, for example. The newly generated data set in the form of a modified annotated image thus no longer contains the corresponding object (although other objects may already be present).

In one embodiment, it may be provided that the other image does not include the annotated image of the at least one object. For example, the other image may have the same background as the annotated image, for example only the background in the annotated image—that is to say, without the object(s).

In one embodiment, it may be provided that the annotation contains information about the size and position of the at least one object in the annotated image and/or a segmentation, i.e., information about all the pixels associated with the object in the annotated image.

Embodiments further provide a system that includes a first interface, a second interface and a computing facility. The first interface is configured to receive at least one annotated image, the annotated image having at least one object with an annotation (label) assigned to the at least one object, the annotation describing or defining an image area (area of the image) in which the at least one object is contained. The computing facility is configured to select an object in the annotated image, and to remove the image area described by the annotation in order to remove the selected object together with the annotation assigned to the selected object from the annotated image and thus to generate a modified annotated image, (and to add the modified annotated image to the training image data). The second interface is configured to provide the training image data containing the modified annotated image (MAB).

Embodiments further provide a method for training a function. A method for training a function is provided where a (for example, untrained or pretrained) function is trained with training image data, the training image data being provided according to the aforementioned method.

Embodiments further provide a trained function for use in checking the accuracy of the population of printed circuit boards in the production of printed circuit boards, the function being trained as described above. The method for checking the accuracy of the population of printed circuit boards in the production of printed circuit boards includes where the accuracy of the population of printed circuit boards in the production of printed circuit boards is checked by (or by) a trained function, the function being trained with training image data, the training image data being provided according to the aforementioned method. In this case, at least one image of a printed circuit board assembly produced according to a specific process step of a process (printed circuit board assembly production process) is provided, for example by a camera. The at least one image is then checked using the trained function, that may be stored on a computing unit, for example.

### BRIEF DESCRIPTION OF THE FIGURES

FIG. 1 depicts a flow chart of a computer-implemented method,

FIG. 2 depicts possible interim results of the method steps of the method according to FIG. 1,

FIG. 3 depicts a system for generating and providing training image data,

FIG. 4 depicts a system for training an object recognition function, and

FIG. 5 depicts a system for checking the accuracy of the population of printed circuit boards in the production of printed circuit boards.

### DETAILED DESCRIPTION

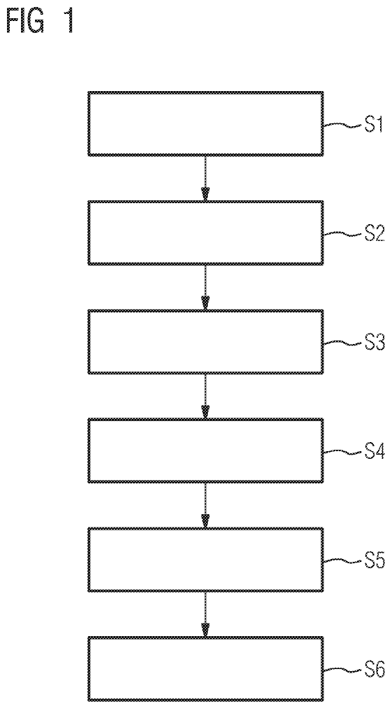

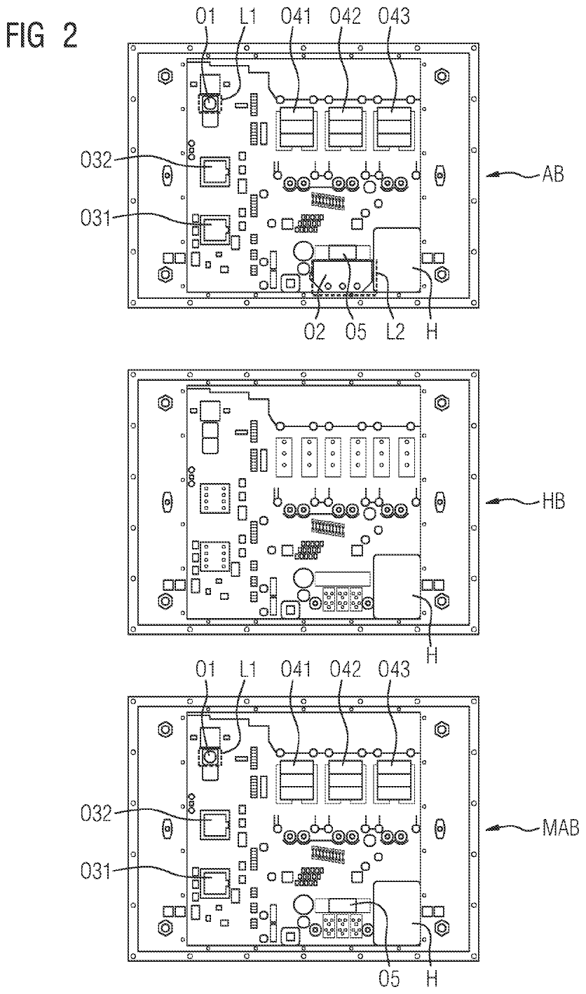

FIG. 1 depicts a flow chart of a computer-implemented method. FIG. 2 depicts possible interim results of the method steps of the method according to FIG. 1.

In a step S1, an annotated image AB (see FIG. 2) is provided.

In the annotated image AB, a plurality of objects O1, O2, O31, O32, O41, O42, O43, O5 may be seen, that may be different. The objects O1, O2, O31, O32, O41, O42, O43, O5 are configured by way of example as electronic components or as their digital images.

A label or an annotation L1, L2 is assigned to each of the objects O1 and O2, a first object O1 being assigned a first label LI and a second object O2 being assigned a second label L2.

The labels L1, L2 define an area of the image AB in which the corresponding object O1, O2 is contained, for example completely contained. The labels L1, L2 may, for example, contain information regarding the heights and widths of corresponding image areas, so that the associated objects O1, O2 are contained in the areas.

The labels L1, L2 may be graphically configured as a border of the corresponding objects O1, O2. The border L1, L2 may be configured as a rectangle and is optimal in such a way that it delimits the smallest possible image area in which the bordered object O1, O2 may still be contained. This means that with a smaller border, the object O1, O2 will not be completely contained in the image area delimited by the smaller border.

FIG. 2 also depicts that the annotated image AB has a background H. The background H has, for example, a printed circuit board or its digital image. The image AB is therefore an image of a (partially populated) printed circuit board.

In a step S2, at least one object is selected in the annotated image AB. That may be, for example, the second object O2.

In a step S3, the selected object O2 and its label L2 is removed from the annotated image AB by removing the image area defined by the label L2, for example overwriting it. This creates a modified annotated image MAB.

The second object O2 is no longer present in the modified image MAB. The second label L2 is not present in the (complete) annotation of the modified annotated image MAB.

In this way, a multiplicity of modified images MAB may be generated, that (for example, together with the annotated image AB) are provided as training image data—step S4.

FIG. 2 also depicts a further image HB. In the image HB, a (partially) unpopulated printed circuit board may be seen, on which none of the objects (to be detected) O1, O2, O31, O32, O41, O42, O43, O5 are depicted.

Such an image HB may be provided alternatively.

The image area defined by the label L2 in step S3 may be removed by overwriting this image area.

For example, a color, for example exactly one color, a random pattern or an area of another image, for example of a background image HB, may be used to overwrite the image area.

It may be expedient that the area of the background image HB with which the image area defined by the label L2 is overwritten, and the area to be overwritten itself correspond to one another, for example that they are of the same size and/or are in the same position.

The modified image MAB has been produced, for example, by such overwriting. Such a modified image MAB is highly realistic and improves the quality and accuracy of a function when it is trained with images of such a nature.

The annotated image AB and the modified, annotated image(s) may be further processed to generate further images for the training image data. For this purpose, a false color representation and/or different gray scales may be used, for example to take into account different lighting scenarios during production. In addition, lighting, color saturation, etc. may be varied. It is understood that the variation of the lighting, color saturation, etc. may also occur during creation, for example when recording the annotated image AB and/or during further processing of the annotated image AB and the modified annotated image(s). For example, the background image HB may be generated in a first shade and the annotated image AB may be generated in a second shade, the first shade differing from the second shade.

By repeating steps S2 and S3, large training data image sets may be rapidly generated.

For n objects, for example, 2ⁿ⁺¹ unique variations in the presence of the objects may be generated. Using the example of a printed circuit board on which, for example, 52 electronic components are present, by way of calculation approximately 9×10¹⁵ different images may therefore be produced from an image 2⁵³ for training.

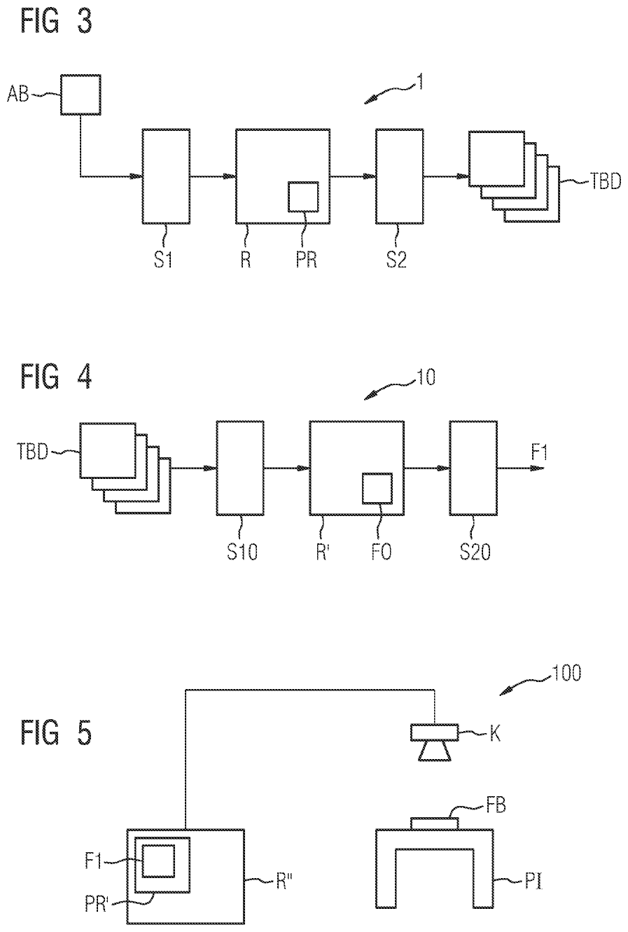

FIG. 3 depicts a system 1 for generating, for example according to the method described above, and providing training image data TBD. The system 1 includes a first interface S1, a second interface S2 and a computing facility R. The first interface S1 is configured to receive the annotated image AB. The computing facility R is configured to select an object O1, O2 in the annotated image AB, and to remove the image area of the annotated image AB described by the annotation L1, L2. As a result, the selected object O1, O2 together with the annotation L1, L2 assigned to the selected object O1, O2 is removed from the annotated image AB and a modified annotated image MAB is generated in this way. For this purpose, the computing facility R may have a computer program PR that includes instructions that, when the computer program PR is executed by the computing facility R, cause the computer program PR to generate the training image data TBD. The computing facility R may then assign the modified annotated image MAB and the annotated image AB to the training image data TBD. The second interface S2 is configured to provide the training image data TBD.

The training image data TBD may be used to train a function, for example an object recognition function F0. FIG. 4 depicts a system 10 for training the object recognition function F0. The system 10 likewise has a first interface S10, a second interface S20 and a computing facility R′. The first interface S10 is configured to receive the training image data TBD. The computing facility R′is configured to train an untrained or pre-trained object recognition function F0 using the training image data TBD, for example, stored on the computing facility R′ or provided to the computing facility R′ before the training, and to generate a trained object recognition function F1. The second interface S20 is configured to provide the object recognition function F1.

Such an object recognition function F1 may be used, for example, to check the accuracy of the population of printed circuit boards in the production of printed circuit boards. FIG. 5 depicts a diagrammatic view of a system 100 that may be used in this case. The system 100 has a computing facility R″. Connected to the computing facility R″ is a camera K, that is configured to capture printed circuit boards FB produced according to a specific process step of a process on a production island PI and to send the captured images to the computing facility R″ for analysis. In order to analyze the images and, for example, to check the completeness of the population of the printed circuit boards FB, the computing facility includes a computer program PR′, that is configured to analyze the images by the trained object recognition function F1. The result of such an analysis may be that electronic components are lacking on a printed circuit board FB, so that a corresponding message is output to the user.

The computing facilities R, R′ and R″ may have approximately the same structure. Both may have, for example, a processor and a volatile or non-volatile memory, the processor being operatively coupled to the memory. The processor is provided to execute corresponding instructions in the form of a code on the memory in order, for example, to generate training image data TBD, to train the (untrained or pre-trained) object recognition function F0 or to carry out the trained object recognition function F1.

The subject matter of this disclosure may be used in various fields other than the assembly checking of the printed circuit boards. Thus, training image data may be generated as described above for training object recognition functions for systems that are used, for example, in the field of autonomous driving. This is based on an annotated image showing a landscape with a road and one or more objects arranged in the landscape. Labels are assigned to the objects. Using this annotated image as a starting point, the method described above may be performed to generate corresponding training image data. Subsequently, an object recognition function for autonomous driving may be trained with this training image data.

In the embodiments and figures, identical or identically acting elements may each be provided with the same reference characters. The reference characters, for example in the claims, are provided only to simplify finding of the elements provided with the reference characters and do not have a restrictive effect on the protected object.

It is to be understood that the elements and features recited in the appended claims may be combined in different ways to produce new claims that likewise fall within the scope of the present embodiments. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present embodiments have been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method for providing training image data for training a function, the method comprises:
providing at least one annotated image, wherein the annotated image includes at least one object comprising an annotation assigned to the at least one object, wherein the annotation describes an image area in which the at least one object is contained,
selecting an object in the annotated image,
replacing the image area described by the annotation with an area of another image to remove the selected object together with the annotation assigned to the selected object from the annotated image and produce a modified annotated image,
providing the training image data containing the modified annotated image.

2. The method of claim 1, wherein the annotated image has a background (H).

3. The method of claim 2, wherein the background has a digital image of a printed circuit board.

4. The method of claim 1, wherein the annotated image comprises a multiplicity of preferably different objects.

5. The method claim 1, wherein the at least one object is designed as a digital image of an electronic component for populating a printed circuit board.

6. The method of claim 1, wherein, in order to generate a plurality of different modified annotated images, selecting and replacing are repeated until the modified annotated image has no more objects, wherein the different modified annotated images are added to the training image data.

7. The method of claim 1, wherein the annotated image and the modified annotated image are processed to generate further annotated images, wherein the further annotated images are added to the training image data.

8. The method of claim 1, wherein the replacement of the image area described by the annotation comprises overwriting the image area.

9. The method of claim 8, wherein a color, a random pattern, or an area of another image is used for overwriting.

10. The method of claim 1, wherein the area of the other image corresponds to the image area, in particular is of the same size and/or is in the same position.

11. The method of claim 1, wherein the annotation contains information about a size and a position of the at least one object in the annotated image and/or about all pixels associated with the object in the annotated image.

12. The method of claim 1, wherein the annotation contains a border of the object.

13. The method of in claim 12, wherein the border is configured as a rectangle and is optimal in such a way that it delimits the smallest possible image area in which the bordered object can still be contained.

14. The method of claim 1, wherein at least one image in which no objects are contained is added to the training image data.

15. The method of claim 1, wherein the selection of an object in the annotated image takes place based on of the annotation assigned to this object.

16. The method of claim 1, wherein the annotation of each object in the annotated image contains information about identification comprising at least one of a type, description, or a nature, of the object the object's position on the image, or a segmentation.

17. The method of claim 1, wherein each object has partial objects.

18. A system for generating and providing training image data for training a function, the system comprising:
a first interface configured to receive at least one annotated image, wherein the annotated image has at least one object with an annotation assigned to the at least one object, wherein the annotation defines an image area in which the at least one object is contained,
a computing facility is configured to select an object in the annotated image, and to replace the image area described by the annotation with an area of another image in order to remove the selected object together with the annotation assigned to the selected object from the annotated image and to generate a modified annotated image,
a second interface configured to provide the training image data containing the modified annotated image.

19. (canceled)

20. (canceled)

21. A method for checking an accuracy of a population of printed circuit boards in a production of printed circuit boards, the method comprising:
providing at least one image is provided of a printed circuit board produced according to a specific process step of a process; and
analyzing the at least one image by a trained function in order to check the accuracy of the population of the printed circuit board, wherein the function has been trained with training image data, wherein the training image data is provided according to a method comprising:
providing at least one annotated image, wherein the annotated image includes at least one object comprising an annotation assigned to the at least one object, wherein the annotation describes an image area in which the at least one is contained,
selecting an object in the annotated image, and
replacing the image area described by the annotation with an area of another image to remove the selected object together with the annotation assigned to the selected object from the annotated image and produce a modified annotated image, and
wherein the training image data contains the modified annotated image.
